(19) United States
(12) Patent Application Publication
(10) Pub. No.: US 2003/0174687 A1
(43) Pub. Date: Sep. 18, 2003

(54) Method and base station for a data transmission from and to user stations using a common timeslot

(76) Inventors: Carsten Ball, Munchen (DE); Ulrich Rehfuess, Munchen (DE); Friedrich Schumacher, Munchen (DE)

Correspondence Address: STAAS & HALSEY LLP, SUITE 700, 1201 NEW YORK AVENUE, N.W., WASHINGTON, DC, 20005, US

(21) Appl. No.: 10/344,149

(22) PCT Filed: Jul. 20, 2001
(86) PCT No.: PCT/DE01/02738

(30) Foreign Application Priority Data
Aug. 8, 2000 (DE) 100 38 667.9

(51) Int. Cl. H04J 3/00

(52) U.S. Cl. 370/345

(57) ABSTRACT

The invention relates to a method for the transmission of data between a number of user stations (MS1, MS2), using a common timeslot of a series of frames and a base station (BS1). The base station (BS1) transmits user data destined for a first of the user stations (MS1) and control information for a second user station (MS2) in a given timeslot, whereby the control information is encoded with a stronger error protection than the user data. A radio signal emitted in the given timeslot directed at the first user station (MS1) is superimposed with a second radio signal, the transmission power of which is sufficient to reach in the direction of the second user station (MS2), in order to permit a precise reception of the control information. The second signal can either be multiplexed or not.

The invention relates to a method for controlling the transmission of data between a base station in a radio communications system and a number of subscriber stations which use the same time slot for communication with the base station, and to a base station which is suitable for this purpose.

Methods such as these are used for the transmission of data services in radio communications systems. The frame structures of conventional radio communications systems such as GSM have for a long time been based on the requirements for speech transmission; this means that a frame is subdivided into a regularly recurring sequence of time slots, with the duration of one time slot and a number of time slots in one frame being designed such that the amount of digitized speech data which can be transmitted within one time slot is that which corresponds to the duration of one frame (for full rate communication) or two frames (for half rate communication). In contrast to speech transmission, the transmission of data services uses data rates which may fluctuate to a major extent over the course of time and may amount to fractions or a (not necessarily integral) multiple of the data rate for a speech connection. In order to allow even data services such as these to be transmitted economically, methods have been developed which allow a number of subscriber stations to use a time-division multiplexing process to use one transmission channel which is in each case defined by the same time slot in successive frames. In this case, the channel is allocated on a packet basis: one packet is transmitted from the base station in the jointly used time slot in each frame, and contains payload data, which is intended for a subscriber station, as well as the address (temporary flow identifier, TFI) of the base station for which the data is intended. In addition, the packet contains the address (Uplink State Flag, USF) of the subscriber station which may transmit the next packet on this channel in the uplink direction (subscriber station to base station).

In order that a subscriber station can identify when it may transmit on the jointly used channel, it must be able to correctly decode the uplink state flags of all the packets transmitted by the base station in that channel, with sufficient reliability. The uplink state flag must therefore be receivable with adequate quality throughout the entire cell of that base station.

This necessity conflicts with the aim of using so-called adaptive antennas or smart antennas to reduce the total transmission power of a base station and hence the risk of interference in adjacent cells, and/or to improve the signal-to-noise ratio (C/I) at a subscriber station. These adaptive antennas have directional characteristics which are considerably narrower than those of a conventional sector antenna, and which can be deliberately aligned with the direction of a receiver. Apart from the main lobe of such a directional characteristic, the transmission power of the adaptive antenna is, however, very low, or even 0 in places. This means that, if an adaptive antenna is used for transmitting data services to a number of subscriber stations via a channel that makes use of a multiplexing process, and the directional characteristic of the adaptive antenna is in each case aligned with the subscriber station which is intended to be the receiver for that specific payload data packet, it is impossible to ensure that a subscriber station which is identified in the uplink state flag is able to receive and to decode that signal.

In order to avoid this problem, a method which is referred to as fixed allocation has been proposed in GSM 04.60. In this method, the time slot is made available exclusively to one subscriber station for a short time, but typically for a large number of packets. In this case, although the beaming effect of adaptive antennas can be used without any restriction, this is associated, however, with increased signalling complexity for channel allocation, and at least partial loss of the gain from the statistical multiplexing process. An approach such as this is uneconomic, in particular for applications such as WAP (Wireless Application Protocol), in which each subscriber station generally requires access to the jointly used channel for a small number of successive frames, and this channel must therefore frequently be switched from one subscriber station to another.

Another solution approach is the concept of so-called uplink granularity. This concept is based on only the first of in each case four successive downlink packets containing a valid USF value which in each case gives the subscriber station identified by it the right to transmit to the base station for time slots in four successive frames. Only the first of these four time slots need be transmitted nondirectionally over the entire cell, so that it can be received by all the subscriber stations which are using that channel; the subsequent three time slots can then be transmitted in a beamed manner. Once again, this solution approach leads to incomplete utilization of the transmission capacity of the channel, since a subscriber station still needs to be allocated four time slots for transmission even if the data to be transmitted by it could be transmitted in fewer time slots.

The object of the invention is to specify a method for controlling the transmission of data between a base station and a number of subscriber stations on a multiplexed channel, which allows frequent changing of the allocation of the channel to the individual subscriber stations with efficient use of the channel at the same time, and which nevertheless allows operation at a low mean transmission power. Furthermore, it is intended to provide a base station which is compatible with the method.

This object is achieved by the method having the features of patent claim 1 and by the base station having the features of patent claim 10 or 11.

The method according to the invention makes use of the fact that, in the case of existing radio communications systems or radio communications systems which are currently being subjected to standardization, in particular such as the GPRS, EGPRS and GERAN, control information such as the uplink state flag USF which [lacuna] the identification of the subscriber station which may transmit in a subsequent frame and/or the transmission power defined by the base station for this subscriber station, is coded with stronger error protection than the payload data, so that this control information can still be decoded correctly by a subscriber station even if the reception signal strength is no longer sufficient for coding the payload data. It is therefore proposed that, in addition to a first radio signal which is beamed in the direction of a subscriber station for which the payload data in the current time slot is intended, a second radio signal be transmitted whose transmission power in the direction of at least one other subscriber station for which the control information is intended is sufficient to allow this subscriber station to correctly receive the control information. In this case, a small fraction of the transmission power of the first signal is sufficient for the transmission power of the second radio signal. Owing to its low power, the second signal does not lead to noticeable interference in adjacent channels, while on the other hand there is no need to transmit time slots which contain a valid uplink state flag nondirectionally with the high transmission power which is required to receive the payload data, and for all the subscriber stations in the cell.

The transmission power of the second radio cell is preferably reduced in comparison to that of the first to such an extent that it is sufficient for correct decoding of the control information with sufficient reliability throughout the entire cell that is covered by the base station, but is not sufficient for decoding the payload data which is likewise contained in the second radio signal and which in any case is of no interest to the subscriber station that is identified in the control information.

The second radio signal can be transmitted nondirectionally, that is to say an antenna with a directional characteristic which cannot be varied and which covers the entire cell of the base station can be used for transmission of this signal.

Alternatively, the second radio signal may be transmitted in the direction of the subscriber station which is identified in the uplink state flag. In a case such as this, the same antenna arrangement at the base station can be used for transmitting the first and second radio signals.

In both cases, the transmission power in the direction of the second subscriber station is preferably 3 dB to 15 dB less than in the direction of the first subscriber station. These values are, of course, dependent on the codings that are used for the uplink state flag and for the payload data and are suitable for the codes that are currently used for GPRS, EGPRS and GERAN. For GPRS CS1/CS2, the transmission power in the direction of the second subscriber station is preferably reduced by about 5 dB, and greater differences may be expedient for other codings.

In order to avoid destructive interference between the two radio signals, they are expediently polarized orthogonally with respect to one another.

If the two radio signals are directional, it may also be practicable and expedient for them to have the same polarization.

Further features and advantages of the invention will be found in the following description of exemplary embodiments and with reference to the attached figures, in which:

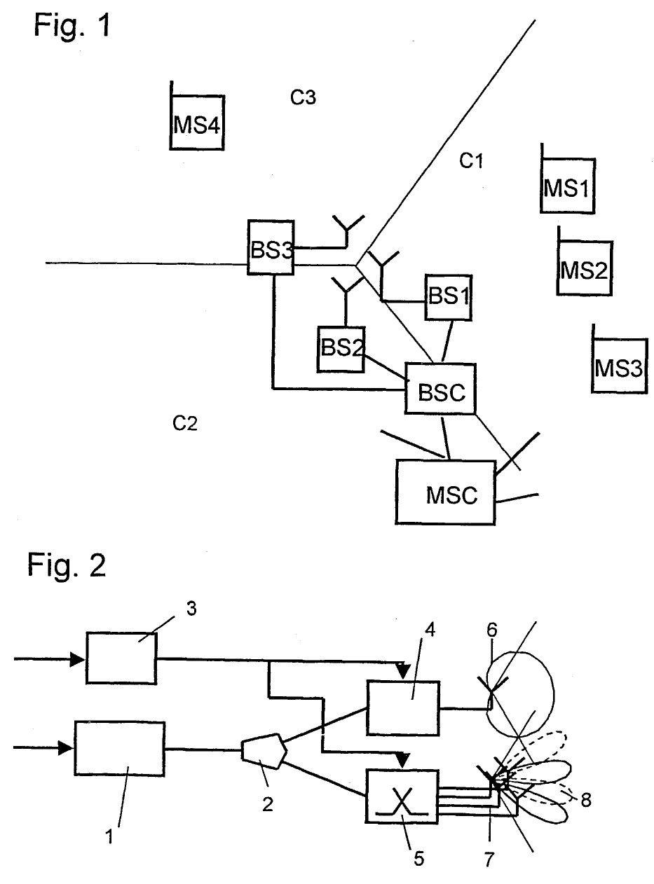

FIG. 1 shows a schematic block diagram of a radio communications system in which the present invention can be used;

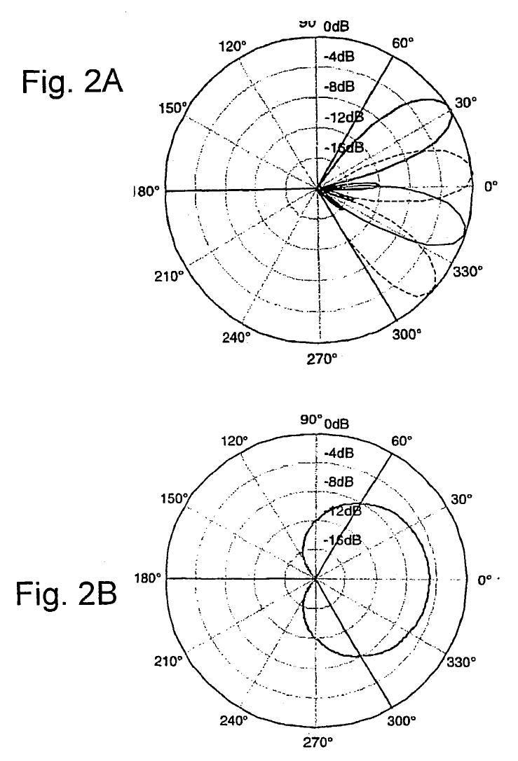

FIG. 2 shows a block diagram of the transmitting section of a base station;

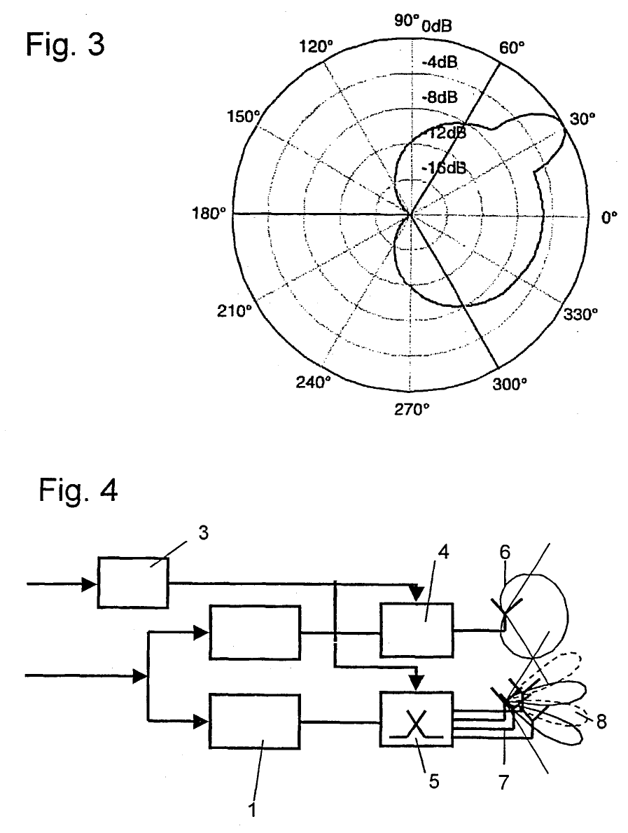

FIG. 3 shows a polar diagram for the transmission section;

FIG. 4 shows a second refinement of the transmission section for the base station;

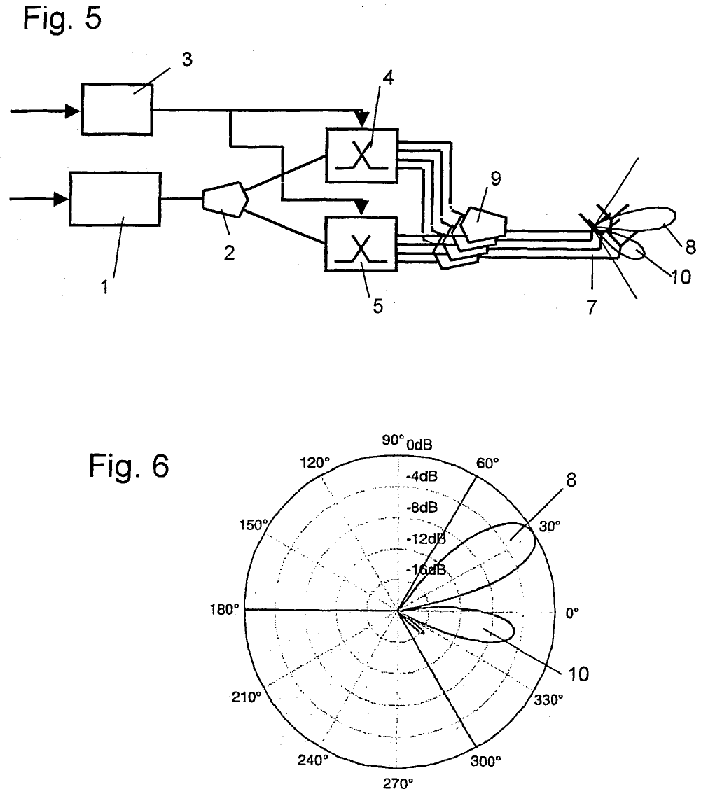

FIG. 5 shows a third refinement of the transmission section for the base station;

FIG. 6 shows a polar diagram for the transmission section.

FIG. 1 shows the structure of a radio communications system in which the method according to the invention can be used. The radio communications network has a large number of mobile switching centers MSC, only one of which is shown in the figure, but which are networked to one another and allow access to other networks, for example to a landline network and/or to a second radio communications network. Furthermore, these mobile switching centers MSC are connected to at least one base station controller BSC. Each base station controller BSC in turn allows a connection to at least one base station, in this case base stations BS1, BS2, BS3. Each such base station may set up a message connection via a radio interface to subscriber stations MS1, MS2, . . . which are located in the corresponding cell C1, C2, C3.

FIG. 2 shows a block diagram of a transmission section for the base station BS1. A radio-frequency amplifier 1 supplies a radio-frequency signal, which is modulated with control information and with the payload data to be transmitted to the subscriber stations, to a power divider 2. The power divider 2 divides the transmission power in a fixed, predetermined ratio between its two outputs, to one of which a polarization selection switch 4 is connected and to the other of which a delay matrix 5 is connected, which are each controlled by an antenna control unit 3. The division ratio is defined as a function of the codings which are used for the payload data and for the control information.

In the case of a GPRS signal, the polarization selection switch 4 receives approximately one quarter of the input power to the power divider 2. Its two outputs supply the radio-frequency signal to in each case one of two orthogonally polarizing transmission elements of a nondirectional antenna 6, in this case a sector antenna whose polar diagram covers the entire cell C1 of the base station BS1. Depending on the position of the polarization selection switch 4, the antenna 6 transmits with a polarization of plus or minus 45°. FIG. 2A shows the polar diagram of this antenna.

The delay matrix 5 receives the remaining three quarters of the input power to the power divider 2 and is a Butler matrix, which supplies an adaptive antenna 7. The adaptive antenna 7 is able to transmit with a number of different polar diagrams depending on the delays which are set by the antenna control unit 3 at the Butler matrix 5 for different transmission elements of the antenna 7, which are each in the form of a narrow lobe 8 with different main propagation directions, as shown in FIG. 2B.

The antenna control unit 3 controls the switch 4 and the Butler matrix 5 such that the polarizations of the radio signals which are transmitted by the antennas 6, 7 are in each case orthogonal. The polarizations of the two signals in each case alternate from one burst of the radio signal to the next.

For each of the subscriber stations MS which are active in the cell C1, the antenna control unit 3 knows the azimuth angle which the subscriber station MS assumes with respect to the base station. In order to transmit a data packet to a subscriber station MS, the Butler matrix 5 thus drives it such that the adaptive antenna 7 produces those of the different lobes 8, which are predetermined by the Butler matrix, whose main propagation direction provides the best match with the azimuth angle of the subscriber station. At the same time, the delay matrix 4 is driven such that the antenna 6 transmits with a polarization which is orthogonal to that of the chosen lobe 8.

FIG. 3 shows a resultant polar diagram. The lobe 8 of the signal of the adaptive antenna 7, which is referred to as the first radio signal, and the cardioid polar diagram of the signal of the sector antenna 6, which is referred to as the second radio signal, are superimposed incoherently on the basis of their orthogonal polarization, so that they do not cancel one another out in the individual propagation directions. By beaming the first radio signal in the direction of the subscriber station MS1, this subscriber station MS1 can reliably receive and decode the payload data which is intended for it. Subscriber stations which are located at different azimuth angles with respect to the base station BS1 receive the second radio signal from the antenna 6, whose transmission power for most directions, predetermined by the division ratio of the power divider 2, is about 5 dB lower in the example under consideration here for most angles than that of the adaptive antenna 7. This definition of the transmission powers from the nondirectional antenna 6 and from the adaptive antenna 7 means that payload data transmitted in a packet can be reliably decoded only in the area of the lobe 8. The uplink state flag may, however, be received reliably by every subscriber station in the cell C1.

The variant of the transmission section which is illustrated in FIG. 4 differs from that shown in FIG. 2 in that there is no power divider 2 and, instead of this, a second radio-frequency amplifier 1′ is provided, so that the antennas 6, 7 each have their own associated amplifier. The transmission power of the amplifier 1 is fixed, so that the entire cell C1 is supplied via the antenna 6 with a radio signal from which all the subscriber stations can extract an uplink state flag. The power of the amplifier 1′ is controllable, so that the transmission power of the adaptive antenna 7 can in each case be deliberately matched as a function of the distance between the base station BS1 and the subscriber station MS1 for which the payload data in the transmitted packet is intended. In the extreme, the transmission power of the amplifier 1′ could even be reduced to 0, if the distance between the base station BS1 and the subscriber station MS1 is so short that even the second radio signal that is transmitted by the nondirectional antenna 6 is sufficient for the subscriber station MS1 to decode the payload data.

FIG. 5 shows a third refinement of the transmission section, from which the antenna 6 has been omitted. Instead of this, the power divider 2 supplies two Butler matrices 5, 5′ with radio-frequency power, with the second matrix 5′ in this case receiving one quarter of the available transmission power, and the matrix 5 receiving three quarters of the available transmission power. The output signals from the two Butler matrices 5, 5′ are combined via T-pieces 9, and are each supplied to individual elements of the adaptive antenna 7. The Butler matrix 5 is controlled by the antenna controller 3 in the same way as that described above with reference to the refinement in FIG. 2. The Butler matrix 5′ is driven by the antenna control unit 3 in order to produce a lobe 10 (see FIG. 6) with a main radiation direction in the direction of a second subscriber section MS2, which is identified in the uplink state flag of the currently transmitted packet.

FIG. 6 shows the resultant polar diagram, with the strong lobe 8, as already illustrated in FIG. 3, in the direction of the subscriber station MS1 for which the payload data in the block is intended, and the second, weaker lobe 10 in the direction of the subscriber station MS2.

If, as is shown in FIG. 6, the difference between the main radiation directions of the lobes 8 and 10 is large, or these lobes do not overlap, they do not need to have the same polarization. If the azimuth angles of the stations MS1 and MS2 differ only slightly and the lobes partially overlap, it may be desirable for them to be polarized orthogonally with respect to one another, in order to avoid destructive interference. Since, specifically, the Butler matrices 5, 5′ allow only discrete polar diagrams, which are predetermined by the composition of the delay paths in the matrices, to be produced, it would otherwise be possible for a situation to occur in which the two lobes 8, 10 actually interfere destructively at the azimuth angle at which the subscriber station MS2 (which has to receive the uplink state flag) or the subscriber station MS1 (for which the payload data is intended) is located.

If the area in which the individual lobes overlap is large enough, the drive for the adaptive antenna can also be simplified by providing the same polarization in each case for all the lobes. Specifically, if the difference in the azimuth angles of the subscriber stations MS1, MS2 is in the same order of magnitude as the beam angle of a lobe, then both subscriber stations may actually be supplied to a sufficient extent by the stronger lobe 8 of the first radio signal. In this situation, there is no need to transmit the second radio signal using the lobe 10. However, if the azimuth angle difference is greater, then it is possible to select two lobes which do not overlap for the first and second radio signals, such as the lobes 8, 10 which are shown in FIG. 6, in which case, since there is no overlap, there is no risk of mutual cancellation at the location of one of the subscriber stations MS1, MS2 for which either the payload data or the control information is intended.

The invention may, of course, also be used for a base station which, instead of a selection of individual, discrete main radiation directions, which are predetermined by the Butler matrix, allows continuous control of the main radiation direction by multiplication of the radio signal, which is passed to the individual transmission elements of the adaptive antenna, by complex weighting coefficients.

1. A method for transmitting data between a number of subscriber stations (MS1, MS2) which use the same time slot in successive frames jointly, and a base station (BS1) in a radio communications system, in which the base station (BS1) transmits payload data, which is intended for a first of the subscriber stations (MS1), and control information for a second subscriber station (MS2) in a given time slot, with the control information being coded with stronger error protection than the payload data, characterized in that a second radio signal is superimposed on a radio signal which is transmitted to the first subscriber station (MS1) in the given time slot, the transmission power of which second radio signal in the direction of the second subscriber station (MS2) is sufficient to allow correct reception of the control information.

2. The method as claimed in claim 1, characterized in that the control information contains an identification for that subscriber station (MS2) which may transmit data in a corresponding time slot in a subsequent frame.

3. The method as claimed in one of claims 1 or 2, characterized in that the control information comprises information relating to the transmission power to be used by the second subscriber station.

4. The method as claimed in one of claims 1 to 3, characterized in that the transmission power of the second radio signal is not sufficient to allow the second subscriber station (MS2) to correctly receive the payload data in the given time slot.

5. The method as claimed in one of claims 1 to 4, characterized in that the second radio signal covers the entire cell (Cl) of the base station (BS1).

6. The method as claimed in one of claims 1 or 4, characterized in that the second radio signal is beamed in the direction of the second subscriber station (MS2).

7. The method as claimed in one of the preceding claims, characterized in that the transmission power in the direction of the second subscriber station (MS2) is 3 dB to 15 dB less than in the direction of the first subscriber station (MS1).

8. The method as claimed in one of the preceding claims, characterized in that the first and second radio signals have orthogonal polarizations.

9. The method as claimed in one of claims 1 to 7, characterized in that the first and second radio signals are directional and have the same polarization.

10. A base station for a radio communications system having an adaptive antenna (7) which is connected to a transmission signal source, for beamed transmission of a first radio signal, characterized in that, in addition, the base station has an antenna for nondirectional transmission of a second radio signal, which antenna is connected to the same transmission signal source and has a lower transmission power than the adaptive antenna (7).

11. A base station for a radio communications system having an adaptive antenna (7) which is connected to a transmission signal source, for beamed transmission of a first radio signal, characterized in that, the base station has means (3, 5, 9) for applying a second radio signal to the adaptive antenna (7), which second radio signal is derived from the same transmission signal source as the first radio signal, the main beam directions of the two radio signals being different, and the transmission power of the second radio signal being less than that of the first.

12. The base station as claimed in claim 10 or 11, characterized in that the base station is set up to transmit the first and second radio signals such they are each polarized orthogonally with respect to one another.

13. The base station as claimed in claim 7, characterized in that the additional antenna (6) and the adaptive antenna (7) are suitable for transmitting radio signals with two respectively orthogonal polarizations.

14. The base station as claimed in claim 11, characterized in that the base station is set up to transmit the first and second radio signals such that they do not overlap and have the same polarization.

15. The base station as claimed in one of claims 10 to 14, characterized in that the transmission power of the second radio signal is between 3 and 15 dB less than that of the first radio signal.
